(19) United States
(12) Patent Application Publication
(10) Pub. No.: US 2018/0075765 A1
(43) Pub. Date: Mar. 15, 2018

(54) SYSTEM AND METHOD FOR TRANSMISSION OF MARKET-READY EDUCATION CURRICULA

(71) Applicant: International Business Machines Corporation, Armonk, NY (US)

(72) Inventors: SARA H. BASSON, White Plains, NY (US); RAGHURAM KRISHNAPURAM, Bangalore (IN); BIKRAM SENGUPTA, BANGALORE (IN); MARK S. SQUILLANTE, Greenwich, CT (US); BO ZHANG, Hoboken, NJ (US)

(21) Appl. No.: 15/260,473

(22) Filed: Sep. 9, 2016

(51) Int. Cl. G09B 5/12; G06Q 30/02

(52) U.S. Cl. CPC G09B 5/12; G06Q 30/0201

(57) ABSTRACT

A method to provide automatic curriculum design includes building a model of benefit of each of a plurality of curriculum models under uncertainty as a function of an expected benefit of each of the curriculum models, building a model of risk of each of the curriculum models under uncertainty as a function of the expected benefit of each of the curriculum models, calculating risk of each of the plurality of curriculum models with the models of risk, calculating benefit of each of the plurality of curriculum models with the models of benefit; and finding a curriculum model among the plurality of curriculum models using the benefit and the risk.

### BACKGROUND

The present disclosure relates to methods for generating and delivering information about job markets.

For generations, students graduating from post-secondary schools were deemed employment-ready. Any unique skills required for particular takes were learned once the employee was on the job, such as through training programs. Currently, there is greater expectation that new hires will enter the workforce with required skill sets.

In some cases this has led to mismatches between candidates and jobs. These mismatches can be ascribed to inadequate guidance about promising growth areas for jobs, the skills required for these particular job classes, available training trajectories prepared for promising areas of employment, and proposed changes to learning plans to be able to improve the match between aptitude/interests and those required by potential job opportunities.

There are no known methods for systematically generating education curricula design/updates based on analysis of labor market data.

### BRIEF SUMMARY

According to an exemplary embodiment of the present invention, a design system is configured to quantitatively model a current market and predict the evolution of future career market. Career options are identified, along with creation of trajectories that predict the course of the career options into the future.

According to an exemplary embodiment of the present invention, a method to provide automatic curriculum design includes building a model of benefit of each of a plurality of curriculum models under uncertainty as a function of an expected benefit of each of the curriculum models, building a model of risk of each of the curriculum models under uncertainty as a function of the expected benefit of each of the curriculum models, calculating risk of each of the plurality of curriculum models with the models of risk, calculating benefit of each of the plurality of curriculum models with the models of benefit; and finding a curriculum model among the plurality of curriculum models using the benefit and the risk.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments may provide one or more of the following advantages:
Determine upcoming career opportunities from both structured and unstructured information sources, via selection of technical methods such as appropriate machine learning techniques tailored for unstructured data;
Predict career availabilities over time taking into account uncertainties using statistical methods such as Bayesian inferences;
Create a mapping from skills to curricula based on analyzing skill-related data, curricula-related data and labor-market-related data, each of which can be unstructured and high-dimensional, using statistical methods motivated by big data;
Making precise recommendations to institutions on how to update existing curricula by applying mathematical optimization techniques to models built on data-based primitives;
Making precise recommendations to individuals on career options and trajectories and how to update both over time by applying mathematical optimization techniques to models built on data-based primitives.

These and other features and advantages of the present invention will become apparent from the following detailed description of illustrative embodiments thereof, which is to be read in connection with the accompanying drawings.

### BRIEF DESCRIPTION OF THE SEVERAL VIEWS OF THE DRAWINGS

Preferred embodiments of the present invention will be described below in more detail, with reference to the accompanying drawings:

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 is a block diagram of a system for generating and delivering information about job markets;

FIG. 5 depicts an exemplary system block diagram and flow chart, according to an embodiment of the present invention;

FIG. 6 depicts another exemplary system block diagram and flow chart, according to an embodiment of the present invention;

FIGS. 7-9 depict input-output diagrams for exemplary computer system embodying a method for generating and delivering information about job markets, according to an embodiment of the present invention; and

FIG. 10 is a block diagram depicting an exemplary computer system embodying a method for generating and delivering information about job markets according to an embodiment of the present invention.

### DETAILED DESCRIPTION

According to an exemplary embodiment of the present invention, market needs and skill trends are determined. When a market need (e.g., role) is identified, a pre-requisite skill set is identified, enabling a student to prepare for the role. A curriculum comprising a set of vetted and well-suited learning materials is prepared automatically, and made available to a teaching institution and/or to individuals. The materials will be designed to accommodate multiple alternative paths for mastering the required skills.

According to an embodiment of the present invention, a curriculum design system is deployed, which receives and integrates data from a plurality of data sources, such as publicly available labor market data, job posting data including both structural and non-structural data, textual data such as job description, job application and applicant data, etc. The integration of these heterogeneous data sources and data types is performed by the curriculum design system using integrative analytics to create a custom designed curriculum.

Herein, the term curricula is intended to encompass curriculums created by an institution and curriculums determined as part of one or more career paths to be followed by an individual. These terms, curriculum/curricula and career path, are used in connection with different exemplary embodiments described herein, which specifically refer to an institution or an individual.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

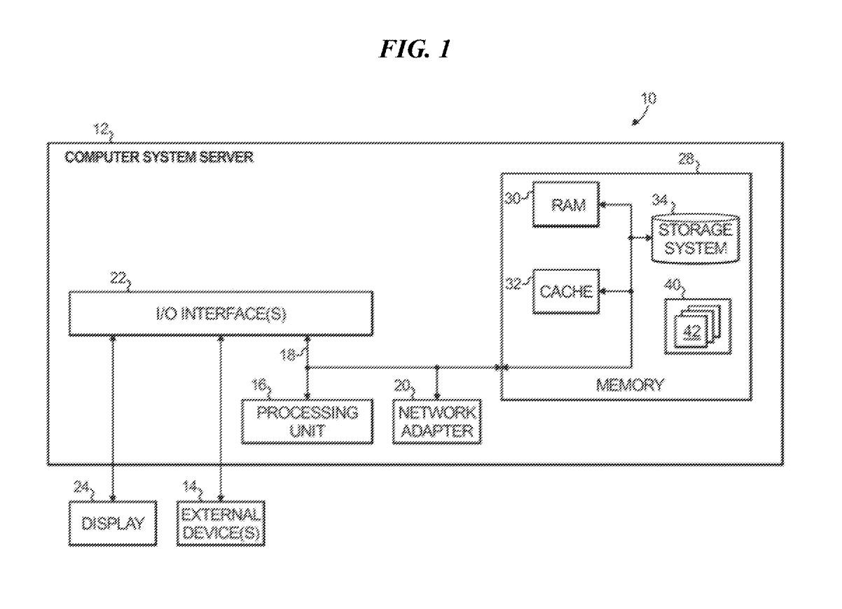

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

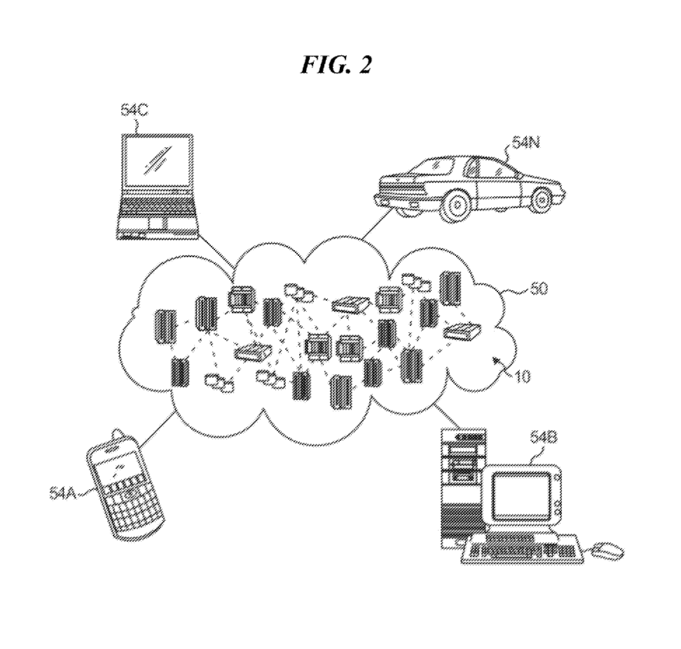

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

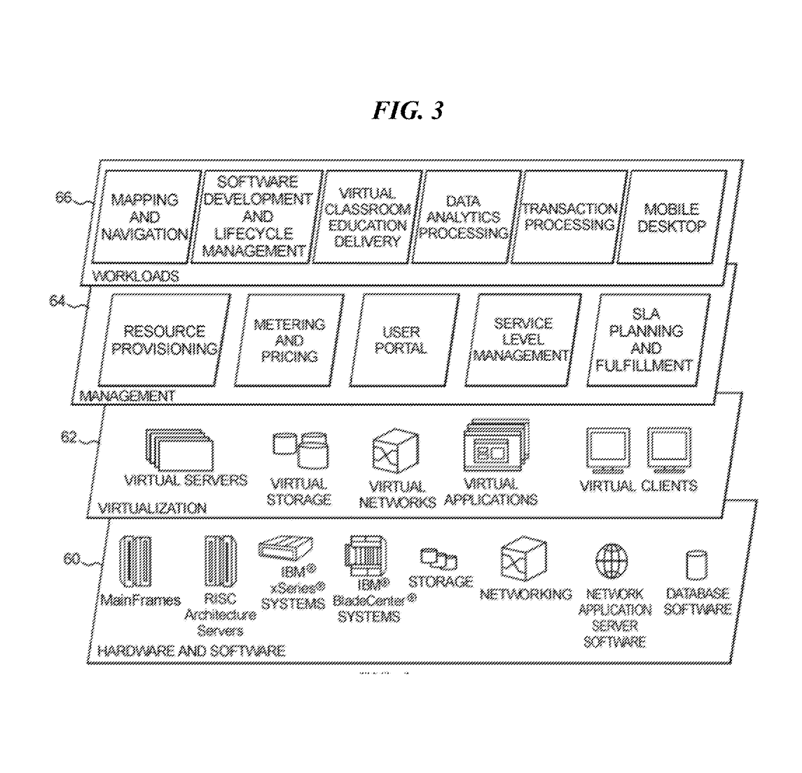

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM Web Sphere® application server software; and database software, in one example IBM DB2® database software. (IBM, zSeries, pSeries, xSeries, BladeCenter, Web Sphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and mobile desktop.

According to an exemplary embodiment of the present invention, a career market is quantitatively modeled and the evolution of a future of the career market is predicted. According to an exemplary embodiment of the present invention, career options are identified, along with the creation of trajectories that predict the course of the career options into the future. These predictions are made for a future time horizon of a length that is appropriate for the specific career option.

According to an exemplary embodiment of the present invention, career opportunities are extracted from one or more data sources, such as company job postings and government materials. According to one or more exemplary embodiments of the present invention, upcoming and new career options are determined based on information related to economic, technological, social, and other trends gleaned from broad-based web materials and media sources using natural language understanding, and combining this information with the current landscape.

According to one or more embodiments of the present invention, predictions about careers are made for a time that a current student is likely to enter the workforce, using stochastic processes and decision making under uncertain conditions. For career opportunities that exist and have been filled, skill profiles of early stage professionals (e.g., with less than about 3 years of experience) are identified, together with the skills needed to be eligible for these roles.

According to an exemplary embodiment of the present invention, correlations among curriculum components and market needs are quantified. A coverage and gap analysis is performed over the existing curriculum and the inferred market needs. Students' career aspirations, aptitudes and risk tolerances are incorporated into the curricula design and recommendation while taking into account the capacity of the market to accommodate such careers.

According to an exemplary embodiment of the present invention, skills for any new career options are estimated based on a nature of the job, its similarities or correlations to existing jobs, and any new skills that the new career option may require. Skills are clustered based on their co-occurrence; that is, a particular role might require expertise in X, Y, and Z. Skills that are required are mapped to existing curricula of certain institutions (e.g., local institutions, institutions with specialized curricula, etc.) to detect coverage (e.g., required skills being taught), redundancies (e.g., skills being taught that are no longer that important) and gaps (e.g., required skills not being taught).

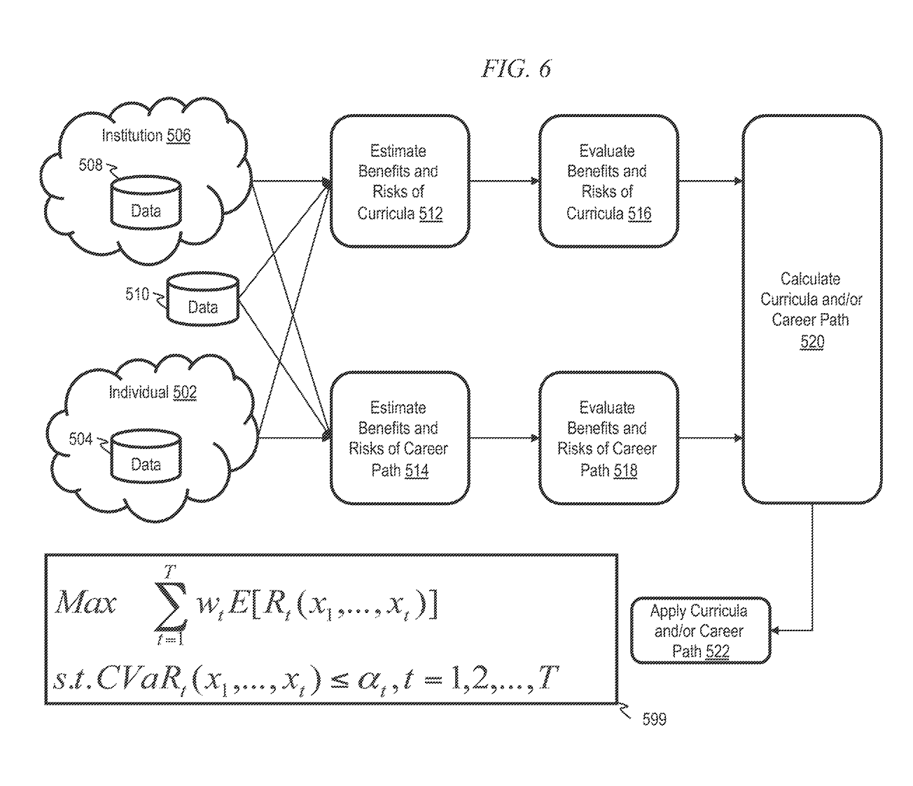

According to an exemplary embodiment of the present invention, appropriate mathematical functions are formulated (see for example, resource allocation function, 599, FIG. 6) that measure the extent to which education curricula are market-ready in terms of associated skills, supply-demand risks, etc. Such mathematical functions serve as building blocks for the predictive modeling, scenario analysis and optimization under uncertainty, which are solved to generate curricula recommendations and incentives. In at least one example, if an institution's focus is on measuring market-readiness in terms of a computer developer career market, the functions can be a weighted sum of a plurality of terms, including 1) the difference between the expected market demand for software architects and the expected supply of qualified software architects under a specific curriculum, 2) the difference between the expected market demand for senior software developers and the expected supply of qualified senior software developers under a specific curriculum, and 3) the difference between the expected market demand for entry-level software developers and the expected supply of qualified entry-level software developers under a specific curriculum. The relative values, but not the absolute values, of the three weights reflect the relative importance of meeting a demand for each of the three career options from the curriculum designer's perspective. Further, the incentives can be used by the institution to encourage students to follow certain parts of the curricula (e.g., a curriculum that is less-used, but highly desired in the marketplace). Exemplary incentives can include scholarship offers, financial assistance, discounts on one or more classes in the curriculum, offers for additional job placement support, etc. In one or more embodiments of the present invention, the incentives are generated for cases in which the recommended curricula together with the incentives provide a solution matching the institution's criteria (e.g., a certain percentage of students tracking curriculums having a job placement potential above a given threshold).

According to an exemplary embodiment of the present invention, a sequence of predictive modeling problems (i.e., optimization under uncertainty) over time and corresponding scenario analysis are solved using collected data, a set of constraints (e.g., course pre-requisites, total credit hours, constraints imposed by certification bodies such as ABET (Accreditation Board for Engineering and Technology), etc.), and a desired evaluation function.

According to an exemplary embodiment of the present invention, the modeling of the market state is based on information extracted from a variety of structured data sources (e.g., published career clusters) and unstructured data sources (e.g., job descriptions, resumes, media articles). In at least one embodiment of the present invention, this information is collated and organized using domain taxonomies and inference through co-occurrence, allowing a market need to be represented using a collection of skills that are necessary to meet the needs of the market state.

According to an exemplary embodiment of the present invention, high-dimensional stochastic processes are used to model the market-need evolution. For example, instead of having a single-dimensional stochastic process to model and predict the demand for a software engineer role, advantageously a multi-dimensional process is used, where each dimension corresponds to different software engineer roles with different skill levels and/or different areas of expertise/specialization. In at least one exemplary embodiment of the present invention, predictive modeling using high-dimensional stochastic processes takes into account economic, technological and social trends. It should be understood that other trends can be targeted, such as influences coming from an external ecosystem.

According to an exemplary embodiment of the present invention, the predictive modeling allows each market need to be assigned a relevance score based on the strength of a current and predicted demand for the role. The method supports top-down (e.g., organization, institution, curricula), bottom-up (e.g., individual, career, trajectory) and intermediary perspectives for modeling and predicting the evolution of future career market.

According to an exemplary embodiment of the present invention, personalized feedback is provided to students, wherein the feedback indicates a relevancy of particular institutions, based on the quality and relevancy of coverage provided for particular job classes as well as the aptitudes and interests of the students, together with any associated risks. Further, feedback is provided to students on bridge skills they may need to acquire, to get on a path of growth opportunities, together with any associated risks. Recommendations are provided to institutions to update existing curricula of offered courses to reduce redundancies and fill in gaps, e.g., embed new skills teaching in an existing course, suggest new courses when there is no natural mapping, etc. Information on any predicted gap and glut situations that are relevant to the curricula are also provided to the institutions.

According to an exemplary embodiment of the present invention, company names/subject matter experts are linked to the curriculum skills from where internship/job/content may be sourced.

Predictive Models. Structured & Unstructured Analytics:

According to an exemplary embodiment of the present invention, a curriculum design system uses education population data and data mining techniques (e.g., text mining, clustering) to identify factors leading to levels of success/failure and to develop predictive models of the propensity of success/failure for different groups of individuals based on these factors when following various career paths. This includes assessment and characterization of the current state of the population of interest, for example, determining how different groups of individuals are likely to react to different course offerings, different incentives, etc., over multiple time scales.

According to an exemplary embodiment of the present invention, a curriculum design system uses labor market data, machine learning techniques (e.g., high-dimensional regression, sentiment learning) to develop predictive models of future market demand and trends for skills, careers, etc., over multiple time scales; combined with structured and unstructured data analytics to extract, correlate and cluster in-demand/predicted skills into recommended curriculum modules.

According to an exemplary embodiment of the present invention, a curriculum design system uses the curriculum data, data mining techniques (e.g., statistical analysis, clustering) to identify correlation among classes and skills involved and to develop predictive models of the success/quality of curriculum/educational options; semantic gap analysis between existing and recommended curriculum modules are used to estimate market readiness score and propose adjustments (e.g. addition/deletion) of modules to improve market-readiness.

According to an exemplary embodiment of the present invention, the correlations among curriculum components and the market needs are quantified. The courses that a student has taken and his/her academic performance in those courses, as well as any courses that the student has the ability to take in the future determine the student's ability to meet different market needs, where a course can be viewed as a collection of curriculum components covered by it. The inherent uncertainty and risks in this determination relationship can be well captured by inferring from past data and subject matter experts the appropriate probability distributions. Again, the method supports top-down (e.g., organization, institution, curricula), bottom-up (e.g., individual, career, trajectory) and intermediary perspectives, in this case for quantifying the correlations among course training and market needs.

According to an exemplary embodiment of the present invention, a coverage and gap analysis is performed over the existing curriculum and the inferred market needs. Using the correlation between curriculum components and market needs, curriculum components are identified that are well-aligned with market needs, that are weakly/not aligned with market needs, as well as market needs that are not well-served by existing curriculum components. Based on the above analysis, each curriculum component is assigned a readiness score that is proportional to its correlation with relevant market needs, where the score is further adjusted based on the relevance of the market need as computed above. By aggregating and rolling up the scores of the different curriculum components along the curriculum standard, a relevance score of different levels of the standard is achieved. A further analysis of the skills being imparted by a curriculum component and the skills that help meet a specific market need allow a finer grained analysis of the relevance of existing curriculum skills, and the missing skills that are relevant to the market.

Stochastic Optimization/Control:

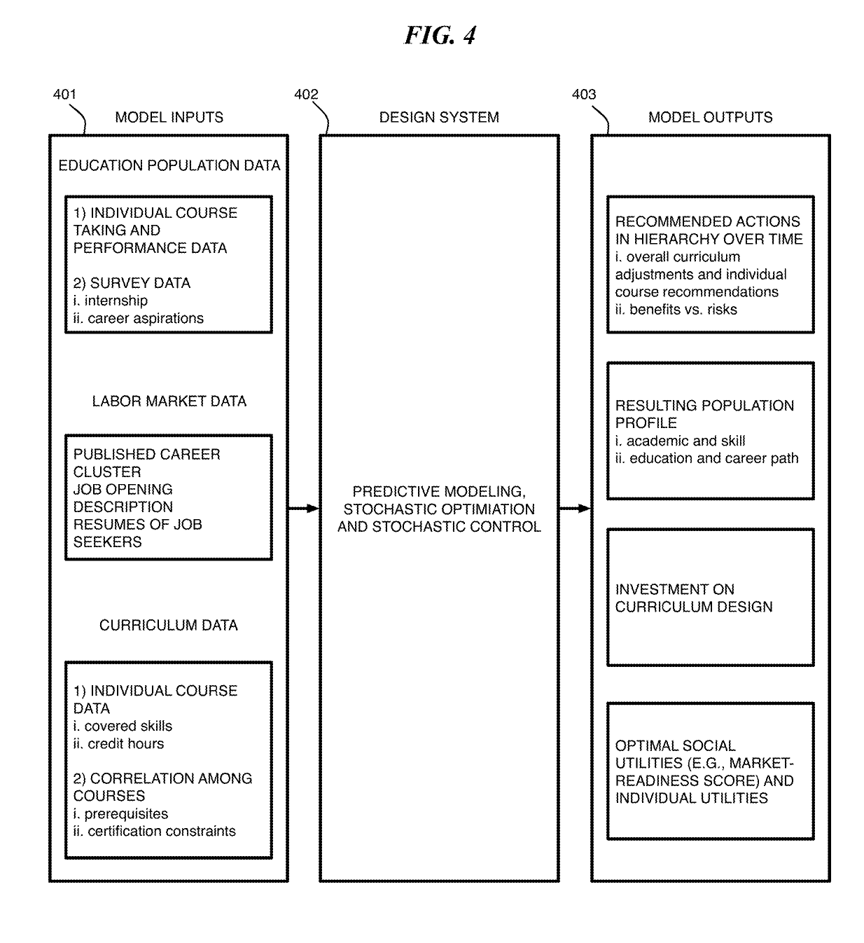

According to an exemplary embodiment of the present invention, as shown in FIG. 4, model inputs 401 including the education population model, labor market model, and curriculum predictive model are processed by stochastic optimization techniques 402 (e.g., Monte Carlo simulation-based optimization, gradient descent algorithm) to determine the model outputs 403 including curriculum/educational options for objectives of interest (e.g., minimize cost, maximize supply-demand match).

It is important to note that model inputs can be complicated mathematical objects, e.g., each input can itself be a statistical model or a stochastic process (e.g., a sequence of statistical models over time). Therefore, the processing of these inputs is tailored to produce outputs of a desired format. For example, when the inputs are probability distributions and statistical models, stochastic optimization techniques, such as sample average approximation methods, are suitable methods for processing the inputs. In another example, when the inputs are probability distributions over time, a stochastic dynamic programming method can be used for processing the inputs.

In one exemplary implementation, a university department designing a core course curriculum including five courses for a master's degree program seeks to improve the job placement of the graduates from the program. The curriculum design system analyzes a variety of data, such as posted job data on public career websites, recruiting event data from the university's career services office, past graduates' survey data, etc. The data analyses performed by the curriculum design system uses machine learning methods implemented in a computer program to create a predictive model of future job markets and a predictive model characterizing how each course can strengthen a student's particular skill, improving job placement. The predictive models can take different forms with different complexity levels, including a relatively simple explicit model using logistic regressions and a more complex model using random forests and neural networks. The predictive models serve as inputs to the curriculum design system and server to identify a selection of the five core courses. The selection of the course uses the students' interests and the job market realities, which are captured in the predictive models. The curriculum design system that performs the analysis and selection of courses implements optimization techniques such as the gradient descent method, which may require thousands of evaluations of different candidate choices.

According to an exemplary embodiment of the present invention, based on education population and labor market predictive models, and with the optimal curriculum solution as constraints, stochastic optimal control techniques (e.g., stochastic dynamic programming) are used to determine the best allocation of groups of individuals across various educational/curriculum paths over time for objectives of interest (e.g., maximize supply-demand match, maximize economic factors). This includes actions to incentivize individuals to follow optimal top-down solution

According to an exemplary embodiment of the present invention, based on education population and labor market predictive models, and with the optimal curriculum solution as constraints, stochastic optimal control techniques (e.g., stochastic dynamic programming, gradient descent algorithm) are used to determine the best educational/curriculum paths for an individual to pursue over time for his/her objectives of interest (e.g., maximize long-term career, maximize short-term benefits). According to an exemplary embodiment of the present invention, the final outputs result from these stochastic optimization/control solutions.

According to an exemplary embodiment of the present invention, the method generates recommendations to add new skills, to remove existing skills from a curriculum component, or to create a new curriculum component covering a cluster of skills for a relevant market need. In this way, a market-ready curriculum is prepared.

Students' personal career aspirations and aptitudes are incorporated into the curricula design and recommendation while taking into account the capacity of the market to accommodate such careers. Each individual's career aspiration (or utility function) has both an endogenous aspect and also an exogenous one (i.e., a student's course training can influence his/her career interest). The individual's career aspiration is probabilistically determined based on his/her course training. Each individual's aptitude, where they stand currently in the knowledge graph and what type of material they respond to, e.g., visual, audio, are different. The individual's aptitude is probabilistically modeled and the curricula design is optimized and recommended under uncertainty. While making recommendations with respect to curricula, the method takes into account both individual career aspirations as well as market needs. In doing so, individual aspirations may be further shaped or influenced by the results of market need analysis. According to an exemplary embodiment of the present invention, the method supports top-down (e.g., organization, institution, curricula), bottom-up (e.g., individual, career, trajectory) and intermediary perspectives, in this context, for incorporating personal career aspirations into the curricula design.

According to an exemplary embodiment of the present invention, the method includes formulating appropriate mathematical functions that measure an extent to which education curricula are market-ready in terms of associated skills as well as supply-demand risks. Such functions serve as building blocks for the predictive modeling, scenario analysis and optimization under uncertainty problems that are solved to generate recommendations and incentives. One example of such a measurement function (or a score) is the (weighted) difference between the market needs for various skills and the skills addressed by the curriculum. Another example of such a measurement function is the difference between the supply resulting from each curriculum and the demand, with respect to the multi-dimensional processes mentioned above, over a time horizon of interest. The smaller such a difference, the more market-ready a curriculum.

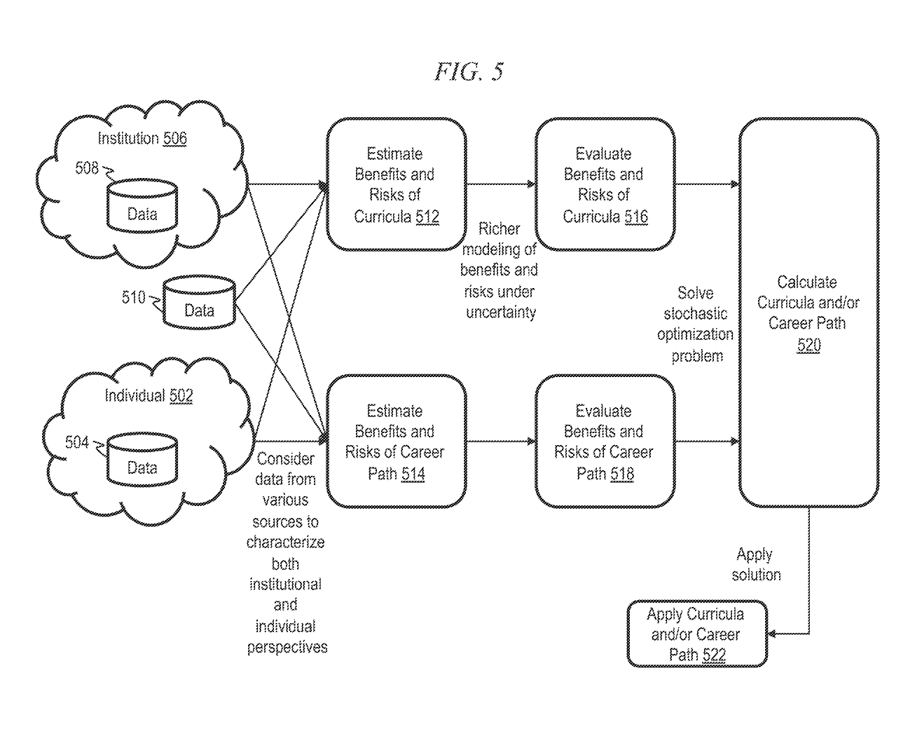

Referring now to FIG. 5, in at least one an exemplary embodiment of the present invention, one or more individual characteristics and perspectives 502 are obtained from one or more sources of data 504. Analogously, one or more institutional characteristics and perspectives 506 are obtained from one or more sources of data 508. These and other data sources, e.g., 510, are used as decision-making input. Exemplary methods described herein are embedded in a system that develops such characteristics, perspectives and decision-making inputs. These methods make use of multiple sources of data to infer time-dependent probabilistic characterizations of such characteristics, perspectives and decision-making inputs. The benefits and risks of an institution proceeding in a certain way with respect to curricula are estimated at 512, while the benefits and risks on an individual proceeding in a certain way with respect to career path are estimated at 514.

Benefits and risks can be functionals (used in this context as functions of functions) of various criteria of interest to the individual or the institution or both, such as the estimated success of a career path together with its risks and rewards over time and the estimated success of a curricula together with its risks and rewards over time, all of which are uncertain. One or more measurements of the benefits and risks for the institution are determined at 516. These measurements include for example, mean or variance of success, revenue and/or cost of a curricula or probability of success, revenue and/or cost exceeding a certain value. One or more measurements of the benefits and risks for the individual are determined at 518 and include, for example, mean, variance, Value-at-Risk (VaR) or Conditional Value at Risk (CVaR) of success, revenue and/or cost of a career path or probability of success, revenue and/or cost exceeding a certain value. The benefits and risks are evaluated in a snapshot or over a period of time (e.g., using multiple snapshots). A best or preferred curricula from the perspective of an institution, or a best or preferred career path from the perspective of an individual, or both, is/are determined at 520 using tools such as stochastic optimization. One or both of the determined curricula/career paths are applied at 522. Advantageously, improved modeling of the benefits and risks under uncertainty is provided, as compared to prior art techniques. The improved modeling results in greater and more precise recommendations on curricula from an institution perspective (e.g., a successful curricula with low risk of failure and low costs) and career path from an individual perspective (e.g., a successful career with low risk of failure and high rewards), as compared to prior art techniques.

According to an embodiment of the present invention, the application of the determined curricula 522 can include for example, outputting the selected curriculum to a user interface through a school's online career portal.

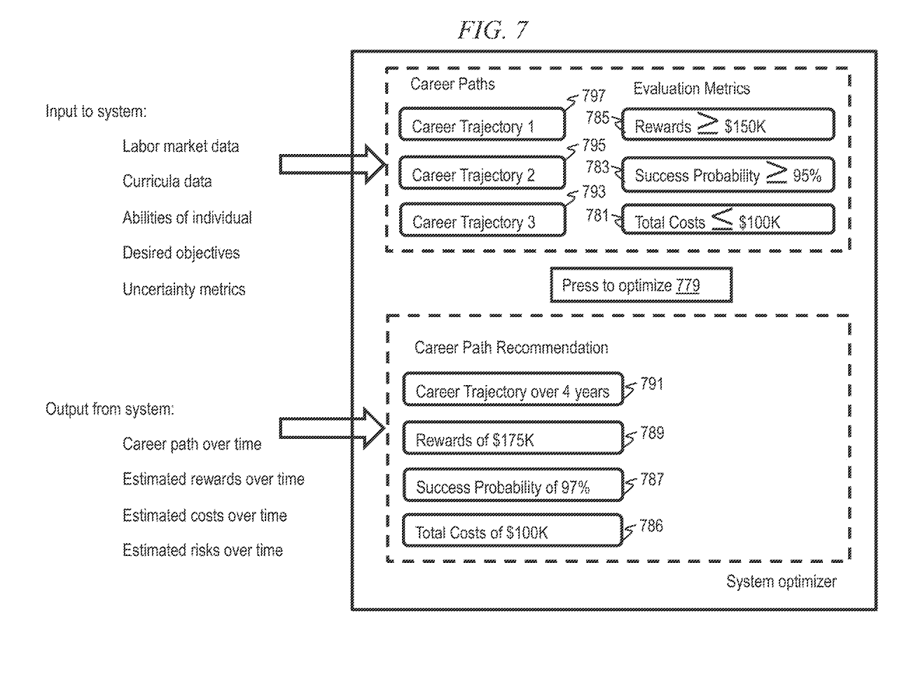

According to an embodiment of the present invention, from the perspective of an individual, an example of an applied career path 522 includes outputting, through the user interface of a school's online career portal, a recommended career path having a high correspondence (e.g., a best match determined by an optimization) to the individual's criteria. The user interface includes selections for the individual to modify the criteria, rerun an optimization (e.g., by selecting button 779 in FIG. 7), and obtaining an alternative recommended career path selecting using the revised criteria. This process can be repeated until the individual finds a career path fitting their needs and desires. Furthermore, the career path output by the system can include one or more corresponding recommended curriculum.

According to an embodiment of the present invention, from the perspective of an institution, applying the determined curricula 522 can include outputting recommended curricula (curricula having a high correspondence to the institution's criteria) to a curricula development system, wherein the institution can provide different curricula to students for their development, but constrained by the institution's criteria. According to at least one embodiment of the present invention, the school administration modifies the institution's criteria, reruns the optimization (e.g., by selecting button 779 in FIG. 7), and obtains an alternative recommendation on curricula that provides alternatives having a high correspondence to the revised criteria. This process can be repeated periodically.

Referring to FIG. 6, wherein like reference characters refer to like elements, consider, as at 599, a resource allocation approach is constructed using:

xₜ: career path decision for individual or curricula decision for institution, or both, at time t;

Rₜ(x₁, x₂, . . . , xₜ): benefit function for individual or institution or both at time t;

CVaRₜ(x₁, x₂, . . . , xₜ): risk measure for individual or institution or both at time t;

αₜ: risk tolerance level for individual or institution or both at time t; and

wₜ: weight applied to benefit at time t.

The values for wₜ at each time t provide the ability to weight the importance of a benefit with respect to time. As an illustrative example, not restricting the idea of weighted benefit, one can put greater importance on benefits in the short term or greater importance on benefits in the long term, or any options in between.

Referring again to the exemplary resource allocation method, 599, in one exemplary embodiment, an optimization (e.g., maximum) is used to search for a career having an expected benefit (i.e., E[Rₜ(x₁, x₂, . . . , xₜ)]), for example, an average salary, a maximized measure of job satisfaction, etc., such that (s.t.) the CVaR for the individual at time t is less than or equal to a risk tolerance level for the individual at time t.

As seen in FIG. 7, in one or more exemplary embodiments, inputs to the system include labor market data, curricula data, abilities and propensities of individual, desired objectives of individual, and uncertainty metrics. In this non-limiting example, the career paths 797, 795, 793 include career trajectories 1, 2, and 3; while the metrics include annual compensation within 5 years of at least $150,000 as at 785, the probability of success of at least 95% as at 783, and the total costs of no more than $100,000 as at 781. Furthermore, the output from the system includes a detailed set of recommendations for best or preferred career trajectory over time. In this non-limiting example, the recommendation of best or preferred career trajectory over time 791 renders an expected annual compensation within 5 years of $175,000 as at 789, an expected probability of success of 97% as at 787, and an estimated total cost of $100,000 as at 786; the time to realize this career trajectory is 4 years. FIG. 7 also represents an exemplary screen shot of a system optimizer wherein the individual may press or click a “press to optimize” button 779 to initiate the optimization process.

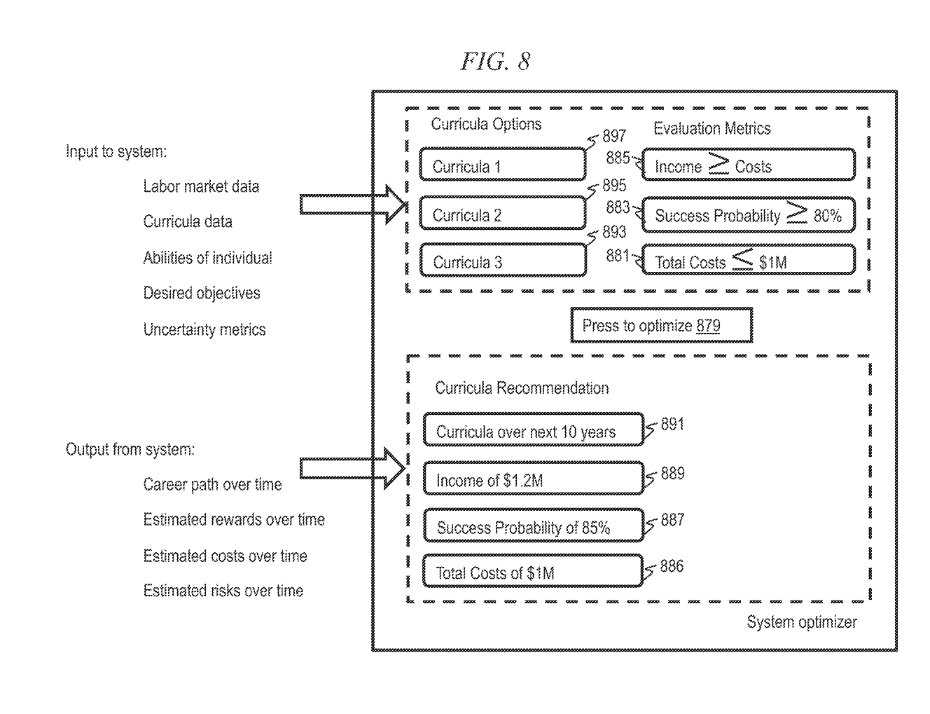

As seen in FIG. 8, in one or more exemplary embodiments, inputs to the system include labor market data, curricula options and data, student populations and data, desired objectives of institution, and uncertainty metrics. In this non-limiting example, the curricula options 897, 895, 893 include curricula 1, 2, and 3; while the metrics include having projected income match or exceed projected costs over 10 years as at 885, the probability of success of the curricula of at least 80% as at 883, and the total costs of no more than $1,000,000 as at 881. Furthermore, the output from the system includes a detailed set of recommendations for best or preferred curricula over the 10-year time horizon. In this non-limiting example, the recommendation of best or preferred curricula over time 891 renders a projected income of $1,200,000 over the 10-year time horizon as at 889, an expected probability of successful completion of 85% as at 887, and an estimated total cost of $1,000,000 as at 886; the time horizon to realize these curricula is 10 years and the solution provides recommendations and results over this entire horizon. FIG. 8 also represents an exemplary screen shot of a system optimizer wherein the institution may press or click a “press to optimize” button 879 to initiate the optimization process.

The one or more embodiments illustrated in FIGS. 7 and 8 can be combined to provide a joint set of recommendations and results for both an individual and an institution.

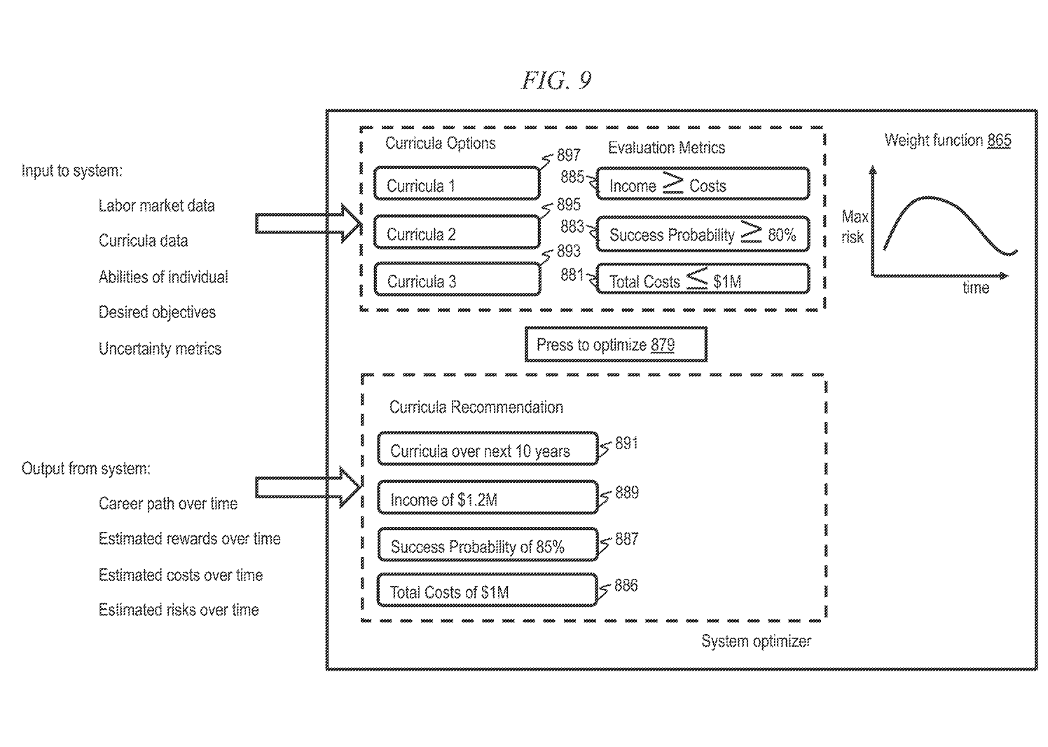

As seen in FIG. 9, in one or more exemplary embodiments, inputs to the system include labor market data, curricula options and data, student populations and data, desired objectives of the institution, uncertainty metrics, and a weight function (wₜ). In this non-limiting example, the curricula options 897, 895, 893 include curricula 1, 2, and 3; while the metrics include having a projected income match or exceed projected costs over 10 years as at 885, a probability of success of the curricula of at least 80% as at 883, and a total costs of no more than $1,000,000 as at 881; and the weight function includes maximum tolerable risk as a function of time, as seen at 865. In at least one exemplary embodiment, the weight function 865 is modified using a preference profile of the individual or institution. The weight function makes it possible for the individual or the institution, or both, to weight a reward more or less heavily based on a time period. For example, one individual may care more about rewards in a shorter term whereas another individual may forego rewards in the shorter term in favor of greater rewards in a longer term.

According to at least one exemplary embodiment of the present invention, the preference profile of an individual specifies a preferred career, or more than one preferred career. Furthermore, the output from the system includes a detailed set of recommendations for best or preferred curricula over the 10-year time horizon. In this non-limiting example, the recommendation of best or preferred curricula over time 891 renders a projected income of $1,200,000 over the 10-year time horizon as at 889, an expected probability of successful completion of 85% as at 887, and an estimated total cost of $1,000,000 as at 886; the time horizon to realize these curricula is 10 years and the output provides recommendations and results over this entire horizon. FIG. 9 illustrates an exemplary screen shot of a system optimizer wherein the institution may press or click a “press to optimize” button 879 to initiate the optimization process.

The methodologies of embodiments of the disclosure may be particularly well-suited for use in an electronic device or alternative system. Accordingly, embodiments of the present invention may take the form of an entirely hardware embodiment or an embodiment combining software and hardware aspects that may all generally be referred to herein as a “processor,” “circuit,” “module” or “system.”

Furthermore, it should be noted that any of the methods described herein can include an additional step of providing a computer system having saccadic vision capabilities. Further, a computer program product can include a tangible computer-readable recordable storage medium with code adapted to be executed to carry out one or more method steps described herein, including the provision of the system with the distinct software modules.

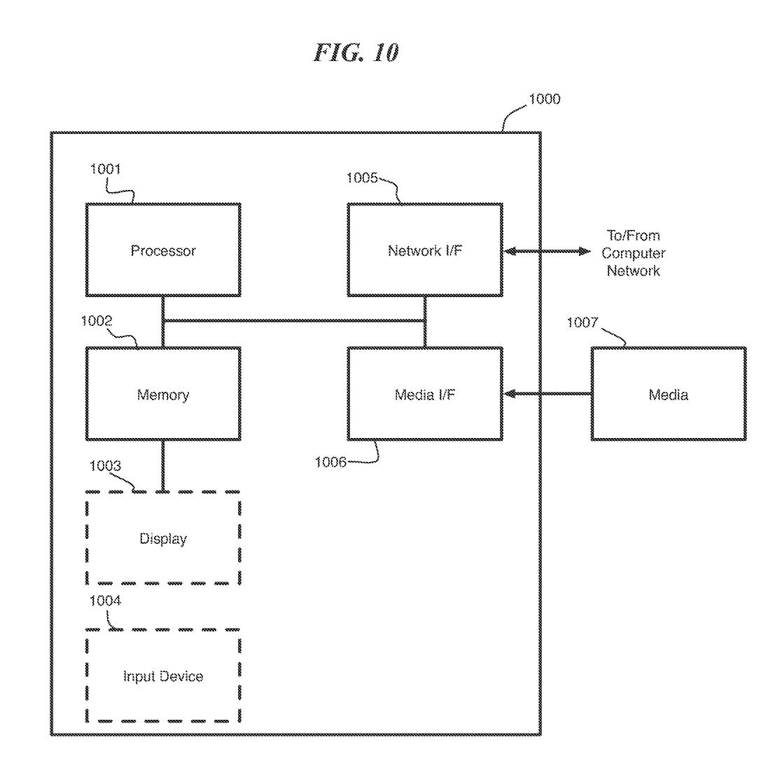

FIG. 10 is a block diagram depicting an exemplary computer system embodying the computer system for generating and delivering information about job markets (see FIG. 4) according to an embodiment of the present invention. The computer system shown in FIG. 10 includes a processor 1001, memory 1002, display 1003, input device 1004 (e.g., keyboard), a network interface (I/F) 1005, a media I/F 1006, and media 1007, such as a signal source, e.g., camera, Hard Drive (HD), external memory device, etc.

In different applications, some of the components shown in FIG. 10 can be omitted. The whole system shown in FIG. 10 is controlled by computer readable instructions, which are generally stored in the media 1007. The software can be downloaded from a network (not shown in the figures), stored in the media 1007. Alternatively, software downloaded from a network can be loaded into the memory 1002 and executed by the processor1 1001 so as to complete the function determined by the software.

The processor 1001 may be configured to perform one or more methodologies described in the present disclosure, illustrative embodiments of which are shown in the above figures and described herein. Embodiments of the present invention can be implemented as a routine that is stored in memory 1002 and executed by the processor 1001 to process the signal from the media 1007. As such, the computer system is a general-purpose computer system that becomes a specific purpose computer system when executing routines of the present disclosure.

Although the computer system described in FIG. 10 can support methods according to the present disclosure, this system is only one example of a computer system. Those skilled of the art should understand that other computer system designs can be used to implement embodiments of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing described systems and methods are, among other things, directed to creating a technical platform (e.g., communications infrastructure, machine learning, decision support system, etc.) that improves the gathering, modeling, and application of digital data for generating, for example, career recommendation data.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method to provide automatic curriculum design, said method comprising:
building a model of benefit of each of a plurality of curriculum models under uncertainty as a function of an expected benefit of each of said curriculum models;
building a model of risk of each of said curriculum models under uncertainty as a function of said expected benefit of each of said curriculum models;
calculating risk of each of said plurality of curriculum models with said models of risk;
calculating benefit of each of said plurality of curriculum models with said models of benefit; and
finding a curriculum model among said plurality of curriculum models using said benefit and said risk.

2. The method of claim 1, wherein said risk of each of said plurality of curriculum models and said benefit of each of said plurality of curriculum models are calculated as a snapshot for a single point in time.

3. The method of claim 1, wherein said risk of each of said plurality of curriculum models is calculated over a given period of time and weighted according to a preference profile.

4. The method of claim 1, wherein said benefit of each of said plurality of curriculum models are calculated over a given period of time and weighted according to a preference profile.

5. The method of claim 1, wherein said model of risk is built for a given period of time and weighted according to a preference profile.

6. The method of claim 5, wherein said step of finding said curriculum model comprises using a stochastic program.

7. The method of claim 1, wherein said expected benefit comprises mean salary.

8. The method of claim 1, wherein said expected benefit comprises a function of mean salary.

9. The method of claim 1, wherein said expected benefit comprises a probability of salary exceeding a given value.

10. The method of claim 1, wherein said risk of each of said plurality of curriculum models comprises a value-at-risk.

11. The method of claim 1, wherein said risk of each of said plurality of curriculum models comprises a conditional value-at-risk.

12. A non-transitory computer readable medium comprising computer executable instructions which when executed by a computer cause the computer to perform a method to select a curriculum, said method comprising:
building a model of benefit of each of a plurality of curriculum models under uncertainty as a function of an expected benefit of each of said curriculum models;
building a model of risk of each of said curriculum models under uncertainty as a function of said expected benefit of each of said curriculum models;
calculating risk of each of said plurality of curriculum models with said models of risk;
calculating benefit of each of said plurality of curriculum models with said models of benefit; and
finding a curriculum model among said plurality of curriculum models using said benefit and said risk.

13. The computer readable medium of claim 12, wherein said risk of each of said plurality of curriculum models and said benefit of each of said plurality of curriculum models are calculated as a snapshot for a single point in time.

14. The computer readable medium of claim 12, The method of claim 1, wherein said risk of each of said plurality of curriculum models is calculated over a given period of time and weighted according to a preference profile.

15. The computer readable medium of claim 12, wherein said benefit of each of said plurality of curriculum models are calculated over a given period of time and weighted according to a preference profile.

16. The computer readable medium of claim 12, wherein said model of risk is built for a given period of time and weighted according to a preference profile.

17. The computer readable medium of claim 16, wherein said step of finding said curriculum model comprises using a stochastic program.

18. The computer readable medium of claim 12, wherein said expected benefit comprises one of a mean salary, a function of mean salary and a probability of salary exceeding a given value.

19. The computer readable medium of claim 12, wherein said risk of each of said plurality of curriculum models comprises one of a value-at-risk and a conditional value-at-risk.

20. In a general purpose computer, a method for providing automatic curriculum design, comprising:
creating a plurality of curriculum design models in a curriculum design system, wherein the curriculum design models include a curriculum data model, an education population model and a labor market model, the plurality of curriculum design models producing a tailored curriculum when the curriculum design artifacts are executed in the curriculum design system;
providing an interface to the curriculum design system to receive queries and output the tailored curriculum;
the curriculum design system performing the steps of:
building a model of benefit of each of a plurality of curriculum models under uncertainty as a function of an expected benefit of each of said curriculum models;
building a model of risk of each of said curriculum models under uncertainty as a function of said expected benefit of each of said curriculum models;
calculating risk of each of said plurality of curriculum models with said models of risk;
calculating benefit of each of said plurality of curriculum models with said models of benefit; and
finding a curriculum model among said plurality of curriculum models using said benefit and said risk.
